(19) United States
(12) Patent Application Publication
(10) Pub. No.: US 2008/0302349 A1
(43) Pub. Date: Dec. 11, 2008

(54) STONE THICKNESS CORRECTING TOOL FOR HANDHELD MACHINES

(76) Inventors: Albert Badal, Canoga Park, CA (US); Wendell Ward, Corvallis, OR (US)

Correspondence Address: KELLY LOWRY & KELLEY, LLP, 6320 CANOGA AVENUE, SUITE 1650, WOODLAND HILLS, CA, 91367, US

(21) Appl. No.: 11/759,786

(22) Filed: Jun. 7, 2007

(51) Int. Cl. B28D 1/32

(52) U.S. Cl. 125/2; 125/3; 125/39

(57) ABSTRACT

A tool for creating uniform thickness around the edge of a stone slab for seaming or profiling thereof. The tool is used with portable routers or other handheld machines. A spindle side spacer, bearing assembly and blade side spacer establish a fixed depth at which the cutting blade is set from the base of the machine. This fixed depth creates a uniform thickness when the tool is used on the edge of a stone slab.

### BACKGROUND OF THE INVENTION

The present invention relates to a tool for use with granite or other hard stones. More specifically, it relates to a tool for preparing the edge of a stone surface for seaming, profiling or similar applications. The tool consists of a bit for use with a handheld machine having rotary action such as a router. The tool includes a cutting blade and spacer assemblies to assure uniform thickness of the edge of the stone surface.

The National Building Granite Quarries Association (NBGQA) is the only association that provides thickness tolerances for granite. The NBGQA's current edition of the specifications for architectural granite lists the allowable variation in thickness for thicknesses between ⅜″ and 1⅝″ as plus or minus ⅛″. The Marble Institute of America Dimension Stone Design Manual adopts this same tolerance. This thickness variation affects the stone fabrication in many ways. Uneven edges, lips and steps are common defects when the thickness variation is outside the stated tolerance.

According to the state of the art, there is a method for correcting the stone edge thickness which is only used on CNC (Computer Numeric Control) machines. In this method an abrasive tool known as a stone stubbing tool or a stone gauging tool is used prior to any profiling or seaming operation to gauge the stone to a predetermined thickness and in a continuous manner for the purpose of obtaining a uniform edge.

In CNC operation, the stone is held in place by vacuum suction tools, polished side down. The machine uses the stone polished side as a datum where either the operator of the machine or a laser device adjusts the thickness width based upon this datum or reference point. When this adjustment is made, based upon a predetermined thickness, the machine engages the stone from a corner and travels along the bottom edge of the stone, i.e., on the rough side, and grinds the overall thickness down to the predetermined thickness. After this operation, the edge of the stone will have a uniform thickness along its length that will help the profiling tools create a consistent edge. The life of the stone surface is extended by avoiding contact with the tools necessary to engage an oversize slab which could potentially damage it.

The tool according to the present invention is designed for a portable handheld machine and is intended to perform the same function as the stubbing tools or gauging tools described above. Since the majority of the stone fabrication shops already use handheld machines for other operations, the present invention will help these fabricators to produce work of the same or similar quality as CNC machines.

### SUMMARY OF THE INVENTION

The present invention is directed to a tool for creating a uniform thickness on the edge of a stone slab. The tool comprises a spindle for attaching the tool to a handheld machine. The spacer assembly comprises a blade spacer, a bearing assembly and a spindle spacer. The spindle spacer is adjacent to the spindle.

A blade is placed adjacent to the blade spacer. The blade is configured such that it engages a surface of the stone slab when the tool abuts the edge of the stone slab. The engagement of the blade with the surface is such that the blade removes material in excess of the uniform thickness. The blade is made by using a layer of an advanced metal bond (sintered) and diamond.

The spacer assembly including the bearing assembly is preferably cylindrical. The cylindrical bearing assembly allows rotation of the tool with respect to the stone slab. The blade is also preferably cylindrical and of a diameter greater than that of the spacer assembly. The depth of the spacer assembly creates a uniform distance between the handheld machine and the blade corresponding to the uniform thickness of the stone slab. The spindle spacer and/or the blade spacer are replaceable to adjust the uniform distance between the handheld machine and the blade.

The present invention is also directed to a process for cutting an edge of a stone slab to a uniform thickness. The process comprises the steps of determining a uniform thickness for the edge of the stone slab. Next, a user provides a handheld tool having a blade and a spacer assembly, wherein the spacer assembly has a depth equal to the uniform thickness. The base of the handheld tool is aligned with an upper surface of the stone slab such that the spacer assembly abuts the edge of the stone slab and the blade engages a lower surface of the stone slab. The handheld tool is then actuated to rotate the blade. Rotation of the blade removes excess material from the lower surface of the stone slab to create the uniform thickness on the edge of the stone slab.

The process may also involve moving the handheld tool from one position on the edge of the stone slab to another position on the edge of the stone slab to create a consistent length of uniform thickness. The step of actuating the handheld tool is repeated until enough excess material is removed to achieve the uniform thickness desired around the edge of the stone slab.

As described above, the spacer assembly is comprised of a spindle spacer, a bearing assembly and a blade spacer. The depth of the spacer assembly is determined by the combined thicknesses of the spindle spacer, bearing assembly and blade spacer. The process may further comprise the step of adjusting the depth of the spacer assembly by replacing the spindle spacer or blade spacer with another spindle spacer or blade spacer having a different thickness.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a front view of the tool of the present invention;

FIG. 2 is an exploded perspective view of the tool of the present invention;

FIG. 3 is a front view of the tool of the present invention engaging a stone slab; and

FIG. 4 is a perspective view of the tool of the present invention engaging a stone slab.

### DETAILED DESCRIPTION OF THE PREFERRED EMBODIMENT

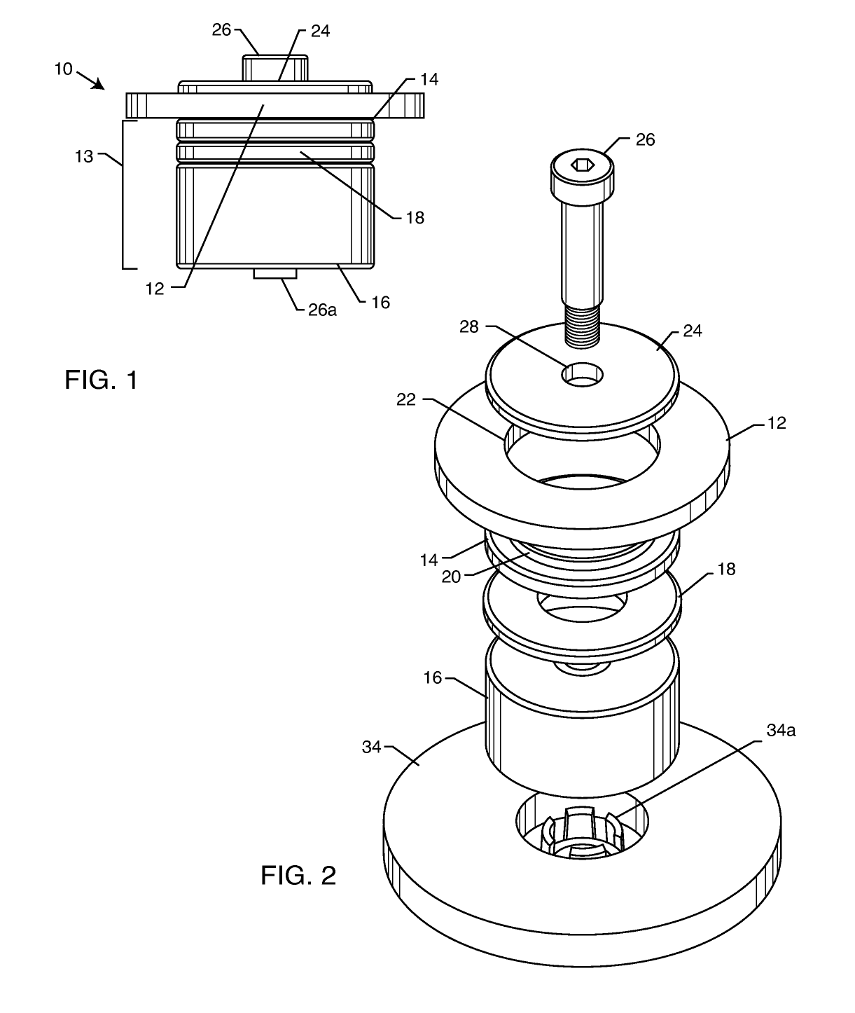

As shown in the drawings for purposes of illustration, the present invention relates to a tool for correcting the thickness of stone slabs, generally referred to in FIGS. 1 through 4 by the reference numeral 10. The tool 10 comprises a bit to be mounted on a portable handheld machine 34 with rotary action such as a router. The tool 10 includes a blade 12. The blade 12 is designed to grind, cut or otherwise remove material from a stone slab which is engaged by the blade 12.

On one side of the blade 12 the tool 10 includes a spacer assembly 13, which includes a blade side spacer 14 and a spindle side spacer 16. Between the blade side spacer 14 and spindle side spacer 16 is a bearing assembly 18.

The blade side spacer 14 is designed to distance the blade 12 from the bearing assembly 18. Likewise, the spindle side spacer 16 is designed to space the bearing assembly 18 from the base of the portable handheld machine 34. The spacer assembly 13, which comprises the combination of the blade side spacer 14, spindle side spacer 16, and bearing assembly 18, sets the depth of the blade 12 from the base of the portable handheld machine 34. This depth determines the thickness of the stone slab 32 after cutting or grinding and creates the uniform thickness required.

The blade side spacer 14 includes a shoulder 20. The shoulder 20 engages a circular opening 22 in the center of the washer-shaped blade 12. The engagement of the shoulder 20 and opening 22 assure that the blade 12 remains in a fixed relationship with the blade side spacer 14.

An end cap 24 engages the blade 12 on the side opposite the blade side spacer 14. A shoulder screw 26 passes through a central opening 28 in the end cap 24. The shoulder screw 26 also passes through concentric central openings in the blade 12, blade side spacer 14, spindle side spacer 16 and bearing assembly 18. A recess 30 in the spindle side spacer 16 permits a nut (not shown) to engage the end of the shoulder screw 26. This engagement of the nut and shoulder screw 26 assures that the parts of the tool 10 are compressed together and remain as a single unit. The nut and shoulder screw 26 may be separated so that the spindle side spacer 16 and/or blade side spacer 14 may be replaced to adjust the fixed depth at which the blade 12 cuts the stone slab 30.

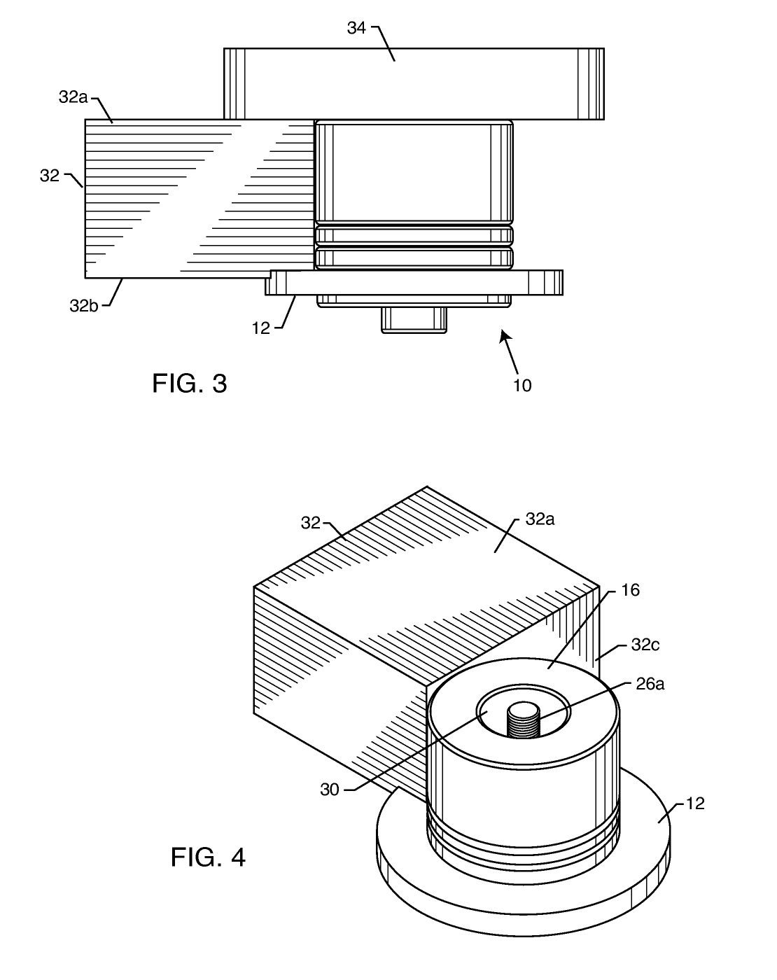

In operation, the tool 10 is connected to a portable handheld machine 34 in the manner in which a tool is usually connected to a router or other machine 34. In one specific embodiment the tool 10 may be connected to a chuck 34a. A spindle 26a on the tool 10 connects to a threaded hole in the chuck 34a. This attachment occurs adjacent the spindle side spacer 16. The tool 10 is then placed adjacent a stone slab 32 as shown in FIG. 3. One side of the spindle side spacer 16 is aligned with an upper or polished surface 32a of the stone slab 32. This alignment is achieved through engagement of the spindle side spacer 16 and the upper surface 32a of the stone slab 32 with the underside 34a of the base of the portable handheld machine 34.

The combination of the blade side spacer 14, spindle side spacer 16 and bearing assembly 18 set the blade 12 a fixed distance from the underside 34a of the machine 34. This fixed distance is also maintained with respect to the upper surface 32a of the stone slab 32. The blade 12 engages the bottom or rough side 32b of the stone slab 32 to cut or grind away that portion of the edge of the stone slab 32 in excess of the predetermined thickness.

The machine 34 imparts a rotational movement to the blade 12. The bearing assembly 18 facilitates the rotational movement of the blade 12 by permitting the blade side spacer 14 to rotate with respect to the spindle side spacer 16. A person using the tool 10 moves the machine 34 along a side 32c of the stone slab 32. The side of the blade side spacer 14, spindle side spacer 16 and bearing assembly 18 is held flush against the side 32c of the stone slab 32. After the tool is passed along the side 32c, that side 32c of the stone slab 32 is ground to the predetermined thickness set by the depth of the tool 10. The user performs this operation on each side 32c of the stone slab 32 to be reduced to the pre-determined thickness.

The blade 12 may be made by using a layer of an advanced metal bond (sintered) and diamond or other material commonly used to cut or grind stone.

Although an embodiment has been described in detail for purposes of illustration, various modifications may be made without departing from the scope and spirit of the invention. Accordingly, the invention is not to be limited, except as by the appended claims.

What is claimed is:

1. A tool for creating a uniform thickness on an edge of a stone slab, comprising:
a spindle for attaching the tool to a handheld machine;
a spacer assembly having a blade spacer, a bearing assembly and a spindle spacer, the spindle spacer being adjacent the spindle; and
a blade adjacent the blade spacer, whereby the blade engages a surface of the stone slab when the tool abuts the edge of the stone slab, such that the blade removes material in excess of the uniform thickness.

2. The tool of claim 1, wherein the blade is made by using a layer of an advanced metal bond and diamond.

3. The tool of claim 1, wherein the spacer assembly is cylindrical and the bearing assembly allows rotation of the tool with respect to the stone slab.

4. The tool of claim 3, wherein the blade is cylindrical and of greater diameter than the spacer assembly.

5. The tool of claim 1, wherein the spacer assembly creates a uniform distance between the handheld machine and the blade corresponding to the uniform thickness of the stone slab.

6. The tool of claim 5, wherein the spindle spacer is replaceable to adjust the uniform distance between the handheld machine and the blade.

7. A tool for creating a uniform thickness on an edge of a stone slab, comprising:
a spindle for attaching the tool to a handheld machine;
a cylindrical spacer assembly having a blade spacer, a bearing assembly and a spindle spacer, the spindle spacer being adjacent the spindle, wherein the bearing assembly allows rotation of the tool with respect to the stone slab;
a blade adjacent the blade spacer, whereby the blade engages a surface of the stone slab when the tool abuts the edge of the stone slab, such that the blade removes material in excess of the uniform thickness; and
wherein the spacer assembly creates a uniform distance between the handheld machine and the blade corresponding to the uniform thickness of the stone slab.

8. The tool of claim 7, wherein the blade is made by using a layer of an advanced metal bond and diamond.

9. The tool of claim 7, wherein the blade is cylindrical and of greater diameter than the spacer assembly.

10. The tool of claim 7, wherein the spindle spacer is replaceable to adjust the uniform distance between the handheld machine and the blade.

11. A process for cutting an edge of a stone slab to a uniform thickness, comprising the steps of:
determining a uniform thickness for the edge of the stone slab;
providing a handheld tool having a blade and a spacer assembly, wherein the spacer assembly has a depth equal to the uniform thickness;
aligning a base of the handheld tool with an upper surface of the stone slab such that the spacer assembly abuts the edge of the stone slab and the blade engages a lower surface of the stone slab;
actuating the handheld tool to rotate the blade, whereby excess material is removed from the lower surface of the stone slab to create the uniform thickness.

12. The process of claim 11, further comprising the step of moving the handheld tool from one position on the edge of the stone slab to another position on the edge of the stone slab.

13. The process of claim 11, further comprising the step of repeating the actuating step until enough excess material is removed to achieve the uniform thickness around the edge of the stone slab.

14. The process of claim 11, wherein the spacer assembly is comprised of a spindle spacer, a bearing assembly and a blade spacer, and the depth of the spacer assembly is determined by the combined thicknesses of the spindle spacer, bearing assembly and blade spacer.

15. The process of claim 14, further comprising the step of adjusting the depth of the spacer assembly by replacing the spindle spacer or blade spacer with another spindle spacer or blade spacer having a different thickness.
